(19) United States
(12) Patent Application Publication
(10) Pub. No.: US 2025/0046285 A1
(43) Pub. Date: Feb. 6, 2025

(54) ULTRASONIC PROJECTION DEVICE

(71) Applicants: Nihon University, Tokyo (JP); Niterra Co., Ltd., Nagoya-shi, Aichi (JP)

(72) Inventors: Hikaru MIURA, Tokyo (JP); Ryota OHFUCHI, Tokyo (JP); Takashi KASASHIMA, Nagoya-shi (JP); Hideaki TAKI, Nagoya-shi (JP)

(21) Appl. No.: 18/718,614

(22) PCT Filed: Feb. 16, 2023
(86) PCT No.: PCT/JP2023/005551

§ 371 Date: Jun. 11, 2024

(30) Foreign Application Priority Data
Feb. 22, 2022 (JP) 2022-026090

(51) Int. Cl. G10K 9/122

(52) U.S. Cl. CPC G10K 9/122

(57) ABSTRACT

An ultrasonic projection device for projecting ultrasonic waves includes a first block body, a second block body, and a piezoelectric unit sandwiched between the first block body and the second block body. A vibration plate is provided at one end on the first block body side in the axial direction of the first block body, the second block body, and the piezoelectric unit. The dimension from the one end to the other end on the second block body side in the axial direction approximately coincides with half of the wavelength of vibration generated by the piezoelectric unit. A connection portion having a groove with a smooth inner wall surface which connects the vibration plate and a base portion is provided between the vibration plate and the base portion which supports the vibration plate.

### TECHNICAL FIELD

The present invention relates to an ultrasonic projection device.

### BACKGROUND ART

In recent years, small-sized ultrasonic projection devices are used as an ultrasonic wave sensor for vehicles and a parametric speaker which projects sound waves while imparting directivity thereto. For example, Patent Document 1 discloses an ultrasonic projection device in which vibrations generated at a vibration section are transmitted to a vibration plate, thereby projecting ultrasonic waves.

### PRIOR ART DOCUMENT

### Patent Document

Patent Document 1: JP2019-97052A

### Problem to be Solved by the Invention

Ultrasonic projection devices are demanded to be small in size and lightweight because they are mounted on vehicles and other apparatus. Moreover, ultrasonic projection devices are demanded to be capable of projecting ultrasonic waves with strong sound pressure despite their small sizes and light weights.

### SUMMARY OF THE INVENTION

The present invention has been accomplished in view of the above-described problem, and an object is to enable an ultrasonic projection device to increase the sound pressure of ultrasonic waves.

### Means for Solving the Problem

The present invention employs the following configurations as means for solving the above-described problem.

A first mode of the present invention is an ultrasonic projection device for projecting ultrasonic waves which employs a configuration comprising a first block body, a second block body, and a vibration generation section sandwiched between the first block body and the second block body, wherein a vibration plate is provided at one end on the side where the first block body is present as viewed in a direction of arrangement of the first block body, the second block body, and the vibration generation section, wherein a dimension in the direction of arrangement from the one end to the other end on the side where the second block body is present approximately coincides with half of the wavelength of vibration generated by the vibration generation section, and wherein a connection portion is provided between the vibration plate and a base portion which supports the vibration plate, the connection portion having a groove with a smooth inner wall surface which connects the vibration plate and the base portion.

A second mode of the present invention employs the following configuration in the above-described first mode; i.e., a forward end member having the vibration plate, the connection portion, and the base portion is provided separately from the first block body, and the forward end member is fixed to the first block body.

A third mode of the present invention employs the following configuration in the above-described first mode; i.e., the first block body has the vibration plate, the connection portion, and the base portion.

A fourth mode of the present invention is an ultrasonic projection device for projecting ultrasonic waves which employs a configuration comprising a first block body, a second block body, and a vibration generation section sandwiched between the first block body and the first block body, wherein the first block body includes a vibration plate provided on a side opposite the vibration generation section in a direction of arrangement of the first block body, the second block body, and the vibration generation section, a base portion abutted against the vibration generation section, and a connection portion provided between the vibration plate and the base portion and having a groove with a smooth inner wall surface which connects the vibration plate and the base portion.

A fifth mode of the present invention employs the following configuration in any of the above-described first to fourth modes; i.e., the groove is annularly formed around a center axis extending in the direction of arrangement, and a sectional shape of the groove on a plane containing the center axis is a semi-elliptical shape which is concave inward from an outer side in a radial direction with respect to the center axis.

A sixth mode of the present invention employs the following configuration in the above-described fifth invention; i.e., the semi-elliptical shape has a minor axis parallel to the center axis and a major axis parallel to the radial direction.

A seventh mode of the present invention employs the following configuration in any of the above-described first to sixth modes; i.e., a bolt which is threadedly engaged, at one end, with the first block body and threadedly engaged, at the other end, with the second block body is provided, wherein the bolt has a center of gravity at a position which is closer to the second block body than to the first block body in the direction of arrangement.

An eighth mode of the present invention employs the following configuration in any of the above-described first to seventh modes; i.e., the first block body is formed of a material whose specific gravity is smaller than that of the second block body.

A ninth mode of the present invention employs the following configuration in any of the above-described first to eighth modes; i.e., a boundary between the first block body and the vibration generation section is located at a position in the direction of arrangement which corresponds to a node of vibration generated by the vibration generation section.

### Effect of the Invention

According to the present invention, a groove is provided in the connection portion which connects the vibration plate and the base portion, which supports the vibration plate. Therefore, an edge portion of the vibration plate can move greatly without being restrained by the connection portion, and the sound pressure of ultrasonic waves projected from the vibration plate can be increased. Furthermore, since the inner wall surface of the groove is smooth, it is possible to prevent occurrence of local stress concentration on the inner wall surface. Therefore, it is possible to increase the amplitude of vibration of the vibration plate, thereby increasing the sound pressure of ultrasonic waves projected from the vibration plate. Accordingly, the present invention enables the ultrasonic projection device to further increase the sound pressure of ultrasonic waves.

### BRIEF DESCRIPTION OF THE DRAWINGS

FIG. 1 Schematic view of an ultrasonic projection device of a first embodiment of the present invention.

FIG. 2 Sectional view schematically showing the structure of the ultrasonic projection device of the first embodiment of the present invention.

FIG. 3 Result of measurement of the admittance characteristic of the ultrasonic projection device of the first embodiment of the present invention.

FIG. 4 Result of measurement of vibration displacement on a vibration surface of the ultrasonic projection device of the first embodiment of the present invention.

FIG. 5 Result of measurement of the directivity characteristic of the ultrasonic projection device of the first embodiment of the present invention.

FIG. 6 Result of measurement of the distance characteristic of the ultrasonic projection device of the first embodiment of the present invention.

FIG. 7 Result of measurement of the relation between input electric power and sound pressure of the ultrasonic projection device of the first embodiment of the present invention.

FIG. 8 Schematic view of an ultrasonic projection device of a second embodiment of the present invention.

FIG. 9 Sectional view schematically showing the structure of the ultrasonic projection device of the second embodiment of the present invention.

FIG. 10 Result of simulation showing a sound pressure distribution which was obtained by changing the minor and major radiuses of a groove in the ultrasonic projection device of the second embodiment of the present invention.

FIG. 11 Sectional view schematically showing the structure of an ultrasonic projection device of a third embodiment of the present invention.

FIG. 12 Sectional view schematically showing the structure of an ultrasonic projection device of a fourth embodiment of the present invention.

### MODE FOR CARRYING OUT THE INVENTION

One embodiment of an ultrasonic projection device according to the present invention will now be described with reference to the drawings.

### First Embodiment

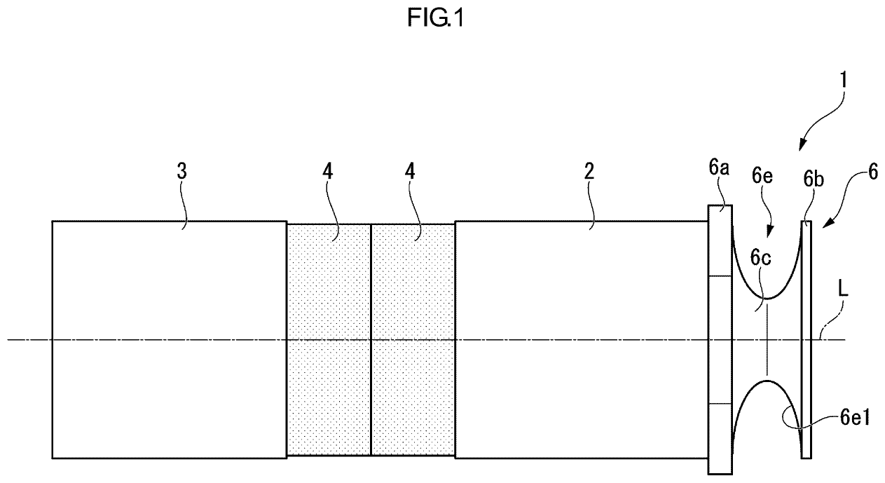

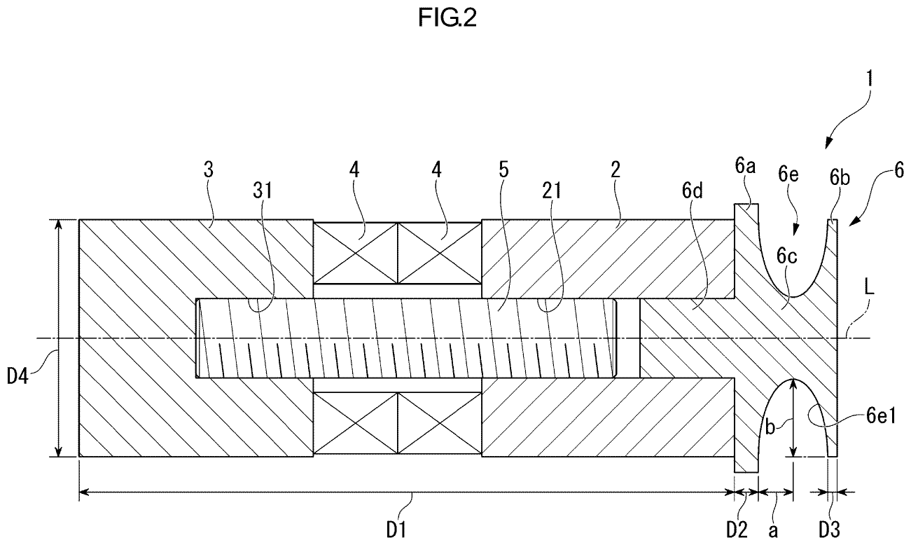

FIG. 1 is a schematic view of an ultrasonic projection device 1 of the present embodiment. FIG. 2 is a sectional view schematically showing the structure of the ultrasonic projection device 1 of the present embodiment. As shown in these drawings, the ultrasonic projection device 1 of the present embodiment is formed in the shape of an approximately circular cylinder whose center coincides with a center axis L. In the following description, for convenience of explanation, a direction along the center axis L will be referred to as the axial direction. A direction extending from the center axis L orthogonally to the center axis L will be referred to as a radial direction. A first block body 2 side as viewed from a second block body 3 in the axial direction will be referred to as the forward side. The first block body 2 and the second block body 3 will be described later. A second block body 3 side as viewed from the first block body 2 side will be referred to as the rear side. However, no particular limitation is imposed on a posture in which the ultrasonic projection device 1 of the present embodiment is installed.

As shown in FIG. 1, the ultrasonic projection device 1 of the present embodiment includes the first block body 2, the second block body 3, piezoelectric units 4 (vibration generation section), a bolt 5, and a forward end member 6. The first block body 2, the second block body 3, and the piezoelectric units 4 are arranged, along the axial direction, in the order of the second block body 3, the piezoelectric units 4, and the first block body 2 from the rear side. Namely, the direction of arrangement of the first block body 2, the second block body 3, and the piezoelectric units 4 coincides with the axial direction.

The first block body 2 is a metal block body formed in the shape of a circular cylinder whose center coincides with the center axis L. The first block body 2 is formed of, for example, aluminum, aluminum alloy, titanium, titanium alloy, stainless steel, iron, or the like. As shown in FIG. 2, the first block body 2 has a through hole 21 penetrating therethrough in the axial direction. The through hole 21 is formed in a center portion of the first block body 2 as viewed from the axial direction. An internal thread for screw engagement with the bolt 5 and the forward end member 6 is formed on an inner wall surface of the through hole 21.

The second block body 3 is a metal block body formed in the shape of a circular cylinder whose center coincides with the center axis L. In the present embodiment, the diameter of the second block body 3 is the same as the diameter of the first block body 2. However, the diameter of the second block body 3 may differ from the diameter of the first block body 2. The second block body 3 is formed of, for example, aluminum, aluminum alloy, titanium, titanium alloy, stainless steel, iron, or the like. The second block body 3 may be formed of the same material as the first block body 2 or may be formed of a material different from the material of the first block body 2.

As shown in FIG. 2, a hole 31 extending in the axial direction is provided in the second block body 3. The hole 31 is formed in a center portion of the second block body 3 as viewed from the axial direction. The hole 31 is formed to be recessed toward the rear side from a surface of the second block body 3 on the forward side. An internal thread for screw engagement with the bolt 5 is formed on an inner wall surface of the hole 31. For example, the diameter of the hole 31 is the same as the diameter of the through hole 21 of the first block body 2. However, the diameter of the hole 31 may differ from the diameter of the through hole 21.

The piezoelectric units 4 vibrate when electric power is supplied thereto from an unillustrated drive section. Namely, the piezoelectric units 4 serve as a vibration generation section for generating vibrations. The piezoelectric units 4 includes, for example, a plurality of disk-shaped piezoelectric ceramic elements stacked together. Each piezoelectric unit 4 is formed in the shape of a circular ring whose center is located on the center axis L. In the present embodiment, each piezoelectric unit 4 has an outer diameter slightly smaller than the diameters of the first block body 2 and the second block body 3. However, the outer diameter of each piezoelectric unit 4 may be the same as or larger than the diameters of the first block body 2 and the second block body 3.

As shown in FIGS. 1 and 2, in the present embodiment, two piezoelectric units 4 are juxtaposed in the axial direction. However, the number of the piezoelectric units 4 may be changed. Namely, the ultrasonic projection device 1 may include a single piezoelectric unit 4. Alternatively, the ultrasonic projection device 1 may include three or more piezoelectric units 4.

These piezoelectric units 4 are disposed between the first block body 2 and the second block body 3 in the axial direction. The first block body 2 is located on the forward side of the piezoelectric units 4. The second block body 3 is located on the rear side of the piezoelectric units 4. These piezoelectric units 4 are sandwiched between the first block body 2 and the second block body 3.

The bolt 5, which extends along the center axis L, is disposed such that the center axis L extends through the bolt 5. The bolt 5 has an external thread formed on its outer circumferential surface. As shown in FIG. 2, the bolt 5 extends through the annular piezoelectric units 4. The first block body 2 is fixed to a forward end portion of the bolt 5, and the second block body 3 is fixed to a rear end portion of the bolt 5. The forward end portion (one end portion) of the bolt 5 is inserted into the through hole 21 of the first block body 2 and is threadedly engaged with the internal thread formed on the inner wall surface of the through hole 21. The rear end portion (the other end portion) of the bolt 5 is threadedly engaged with the internal thread formed on the inner wall surface of the hole 31 of the second block body 3.

As a result of the first block body 2 and the second block body 3 being threadedly engaged with the bolt 5 and the piezoelectric units 4 being sandwiched between the first block body 2 and the second block body 3, the first block body 2, the second block body 3, and the piezoelectric units 4 are united.

The forward end member 6 is a member which is attached to the first block body 2 from the forward side. The forward end member 6 is formed of, for example, aluminum, aluminum alloy, titanium, titanium alloy, stainless steel, iron, or the like. The forward end member 6 may be formed of the same material as the first block body 2 and the second block body 3 or may be formed of a material different from the material of the first block body 2 and the second block body 3. As shown in, for example, FIG. 2, the forward end member 6 includes a base portion 6a, a vibration plate 6b, a connection portion 6c, and a shaft portion 6d.

The base portion 6a supports directly or indirectly the vibration plate 6b, the connection portion 6c, and the shaft portion 6d. The base portion 6a is a disk-shaped portion formed into an approximately circular shape as viewed from the axial direction. The connection portion 6c is connected to the forward side of the base portion 6a. The shaft portion 6d is provided on the rear side of the base portion 6a. In the present embodiment, the diameter of the base portion 6a is slightly larger than the diameter of the first block body 2. However, the diameter of the base portion 6a may be the same as or smaller than the diameter of the first block body 2.

The vibration plate 6b is located forward of the base portion 6a and is connected to the base portion 6a via the connection portion 6c. The vibration plate 6b is a disk-shaped portion formed into a circular shape as viewed from the axial direction. The vibration plate 6b vibrates when vibrations generated by the piezoelectric units 4 are transmitted thereto. As a result of vibration of the vibration plate 6b, ultrasonic waves are radiated. In the present embodiment, the diameter of the vibration plate 6b is the same as the diameter of the first block body 2. However, the diameter of the vibration plate 6b may differ from the diameter of the first block body 2. Namely, the diameter of the vibration plate 6b may be larger or smaller than the diameter of the first block body 2.

The connection portion 6c is provided between the base portion 6a and the vibration plate 6b and supports the vibration plate 6b. This connection portion 6c has a groove 6e annularly provided around the center axis L. The groove 6e has a smooth inner wall surface 6e1 which connects the vibration plate 6b and the base portion 6a. The term “smooth” used herein means that the entirety is formed by a curved surface or a flat surface and a rough portion is not provided.

As described above, the groove 6e is annularly formed around the center axis L along the axial direction. As shown in FIG. 2, a sectional shape of the groove 6e on a plane containing the center axis L is a semi-elliptical shape which is concave inward from the outer side in the radial direction. The minor axis of the semi-elliptical shape is parallel to the center axis L. The major axis of the semi-elliptical shape is parallel to the radial direction.

However, the sectional shape of the groove 6e may be a semi-elliptical shape in which the minor axis is parallel to the radial direction, and the major axis is parallel to the center axis L. The sectional shape of the groove 6e may be a semi-circular shape or a horseshoe shape. The groove 6e may have any sectional shape so long as its entirety is a curved surface or its entirety is a surface which is formed by combining a curved surface(s) and a flat surface(s) and which does not have a rough portion.

The shaft portion 6d is connected at the center of the base portion 6a as viewed from the axial direction and protrudes rearward from the base portion 6a. The shaft portion 6d is formed into a circular columnar shape and has an external thread which is formed on an outer circumferential surface and is screw-engaged with the internal thread of the through hole 21 of the first block body 2. The shaft portion 6d is screwed into the through hole 21 until a rear-side surface of the base portion 6a comes into contact with a forward-side surface of the first block body 2, whereby the forward end member 6 is fixed to the first block body 2.

In the ultrasonic projection device 1 of the present embodiment configured as described above, when electric power is supplied from an external drive section to the piezoelectric units 4, the piezoelectric units 4 vibrate. As a result of setting the drive frequency of the piezoelectric units 4 to the resonance frequency of the ultrasonic projection device 1, the ultrasonic projection device 1 resonates with the vibration of the piezoelectric units 4. As a result, the vibration plate 6b strongly vibrates and ultrasonic waves with high sound pressure are generated. The generated ultrasonic waves are radiated into a space. The ultrasonic projection device 1 of the present embodiment configured as described above projects the ultrasonic waves generated by the vibration plate 6b into the space.

In the present embodiment, an overall length of the ultrasonic projection device 1 is set to half of the wavelength of longitudinal vibration at the time when the ultrasonic projection device 1 resonates as described above. Namely, the overall length of the ultrasonic projection device 1 is set to half of the wavelength of the vibration generated by the piezoelectric units 4. One end of the ultrasonic projection device 1 in the axial direction is a rear-side end surface of the second block body 3. The other end of the ultrasonic projection device 1 in the axial direction is a forward-side surface of the vibration plate 6b. Therefore, the distance dimension from the rear-side end surface of the second block body 3 to the forward-side surface of the vibration plate 6b is set to half of the wavelength of the vibration generated by the piezoelectric units 4. In the ultrasonic projection device 1 of the present embodiment configured as described above, the vibration plate 6b is disposed at a position of a peak of longitudinal vibration at the time when the ultrasonic projection device 1 resonates. As a result, the amplitude of vibration of the vibration plate 6b can be increased, and ultrasonic waves with higher sound pressure can be outputted.

Notably, the condition that the overall length of the ultrasonic projection device 1 coincides with half of the wavelength of the vibration generated by the piezoelectric units 4 is not limited to the case where the overall length of the ultrasonic projection device 1 completely coincides with half of the wavelength of the vibration generated by the piezoelectric units 4. It is permissible that, due to, for example, an error involved in the ultrasonic projection device 1, the overall length of the ultrasonic projection device 1 slightly deviates from half of the wavelength of the vibration generated by the piezoelectric units 4. In the case where the overall length of the ultrasonic projection device 1 approximately coincides with half of the wavelength of the vibration generated by the piezoelectric units 4, ultrasonic waves with higher sound pressure can be outputted.

For example, the overall length of the ultrasonic projection device 1 may be 10% longer than half of the wavelength of the vibration generated by the piezoelectric units 4. Alternatively, the overall length of the ultrasonic projection device 1 may be 10% shorter than half of the wavelength of the vibration generated by the piezoelectric units 4. Further preferably, the overall length of the ultrasonic projection device 1 falls with the range of 99% to 101% of half of the wavelength of the vibration generated by the piezoelectric units 4. This is because the sharpness Q of an ordinary bolt-clamped Langevin-type transducer (BLT) is 100 or greater, and, therefore, the deviation must be within the range of −1% to +1% in order to obtain a practical amplitude (i.e., half the value of the peak).

The ultrasonic projection device 1 of the present embodiment as described above includes the first block body 2, the second block body 3, and the piezoelectric units 4. The piezoelectric units 4 are sandwiched between the first block body 2 and the second block body 3. The vibration plate 6b is also provided in the ultrasonic projection device 1 of the present embodiment. The vibration plate 6b is provided at one end on the first block body 2 side in the axial direction of the first block body 2, the second block body 3, and the piezoelectric units 4. In the ultrasonic projection device 1 of the present embodiment, the dimension between the one end on the first block body 2 side to the other end on the second block body 3 side in the axial direction coincides with half of the wavelength of the vibration generated by the piezoelectric units 4. Alternatively, the dimension between the one end on the first block body 2 side to the other end on the second block body 3 side in the axial direction approximately coincides with half of the wavelength of the vibration generated by the piezoelectric units 4. Furthermore, the connection portion 6c is provided in the ultrasonic projection device 1 of the present embodiment. The connection portion 6c is provided between the vibration plate 6b and the base portion 6a, which supports the vibration plate 6b. The connection portion 6c has the groove 6e having the smooth inner wall surface 6e1 which connects the vibration plate 6b and the base portion 6a.

In the ultrasonic projection device 1 of the present embodiment configured as described above, the groove 6e is provided in the connection portion 6c which connects the vibration plate 6b and the base portion 6a. Therefore, an edge portion of the vibration plate 6b can move greatly without being restrained by the connection portion 6c, and the sound pressure of ultrasonic waves projected from the vibration plate 6b can be increased. Furthermore, since the inner wall surface 6e1 of the groove 6e is smooth, it is possible to prevent occurrence of local stress concentration on the inner wall surface 6e1. Therefore, it is possible to increase the amplitude of vibration of the vibration plate 6b, thereby increasing the sound pressure of ultrasonic waves projected from the vibration plate 6b. Accordingly, the ultrasonic projection device 1 of the present embodiment can further increase the sound pressure of ultrasonic waves.

In the ultrasonic projection device 1 of the present embodiment, the distance dimension from the rear-side end surface of the second block body 3 to the forward-side surface of the vibration plate 6b is set to half of the wavelength of the vibration generated by the piezoelectric units 4. In the ultrasonic projection device 1 of the present embodiment configured as described above, the vibration plate 6b is disposed at the position of the peak of longitudinal vibration at the time when the ultrasonic projection device 1 resonates. As a result, the amplitude of vibration of the vibration plate 6b can be increased, and ultrasonic waves with higher sound pressure can be outputted.

The ultrasonic projection device 1 of the present embodiment has the forward end member 6 which is a member different from the first block body 2. The forward end member 6 has the vibration plate 6b, the connection portion 6c, and the base portion 6a. The forward end member 6 is fixed to the first block body 2. In the ultrasonic projection device 1 of the present embodiment configured as described above, the forward end member 6 can be attached to and removed from the first block body 2. Therefore, for example, the shape of the vibration plate 6b can be changed easily by exchanging the forward end member 6.

In the ultrasonic projection device 1 of the present embodiment, the groove 6e is annularly formed around the center axis L along the axial direction. The sectional shape of the groove 6e on a plane containing the center axis L is a semi-elliptical shape which is concave inward from the outer side in the radial direction. As a result of provision of the groove 6e whose sectional shape is a semi-elliptical shape, as will be described in examples below, ultrasonic waves which are high in directivity and sound pressure can be outputted.

In the ultrasonic projection device 1 of the present embodiment, the semi-elliptical shape, which is the sectional shape of the groove 6e, is such that the minor axis is parallel to the center axis L, and the major axis is parallel to the radial direction. Therefore, it is possible to shorten the overall length of the ultrasonic projection device 1, as compared with the case where the major axis is parallel to the center axis L, thereby reducing the size of the ultrasonic projection device 1.

### Example

Subsequently, the results of an experiment carried out by using the above-described ultrasonic projection device 1 of the first embodiment will be described as an example. In the present example, a bolt-clamped Langevin-type transducer (BLT) for 60 kHz shown in FIG. 2 and having a length dimension D1 of 41.5 mm was used as the first block body 2, the second block body 3, and the piezoelectric units 4. The minor radius a of a semi-elliptical shape, which is the sectional shape of the groove 6e, was set to 2.2 mm. The major radius b was set to 4.9 mm. The dimeter dimension of the base portion 6a was set to 17 mm in order to facilitate the connection between the first block body 2 and the vibration plate 6b. An edge portion of the base portion 6a was cut out by an amount of 1 mm at each of two locations located on opposite sides of the center axis L. The thickness dimension D2 of the base portion 6a was set to 1.5 mm. The diameter dimension of the vibration plate 6b was set to 15 mm. The thickness dimension D3 of the vibration plate 6b was set to 0.5 mm. The diameter dimension D4 of the second block body 3 was set to 15 mm.

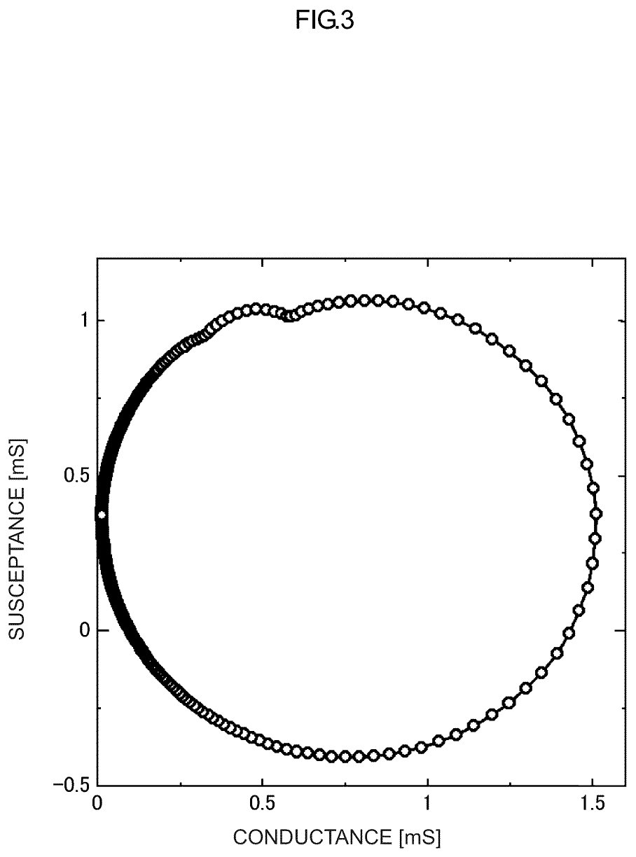

In the present example, the admittance characteristic of the ultrasonic projection device 1 was measured. In this measurement, an impedance analyzer was used. The measurement was performed under the condition that the drive voltage was maintained at 1 V (constant voltage). FIG. 3 shows the results of the measurement of the admittance characteristic. The horizontal axis in FIG. 3 shows conductance. The vertical axis in FIG. 3 shows susceptance. As shown in FIG. 3, the resonance frequency was 48.0 kHz, the value of conductance was 1.51 mS, and the sharpness Q was 267.

Subsequently, the vibration amplitude displacement of the ultrasonic projection device 1 was studied. In this study, the vibration displacement on the vibration surface (the forward-side surface of the vibration plate 6b) was measured. This measurement was performed by using a laser doppler vibration meter. In this measurement, a range extending in the radial direction from the center of the vibration plate 6b by 7.5 mm was defined as a measurement range, and measurement was performed at intervals of 0.5 mm in the radial direction. The drive frequency of the piezoelectric units 4 was set to 48.0 kHz, which is the resonance frequency of the ultrasonic projection device 1. The input current supplied to the piezoelectric units 4 was maintained at 50 mA (constant current). At that time, the voltage was 34.5 V, and the power was 1.7 W.

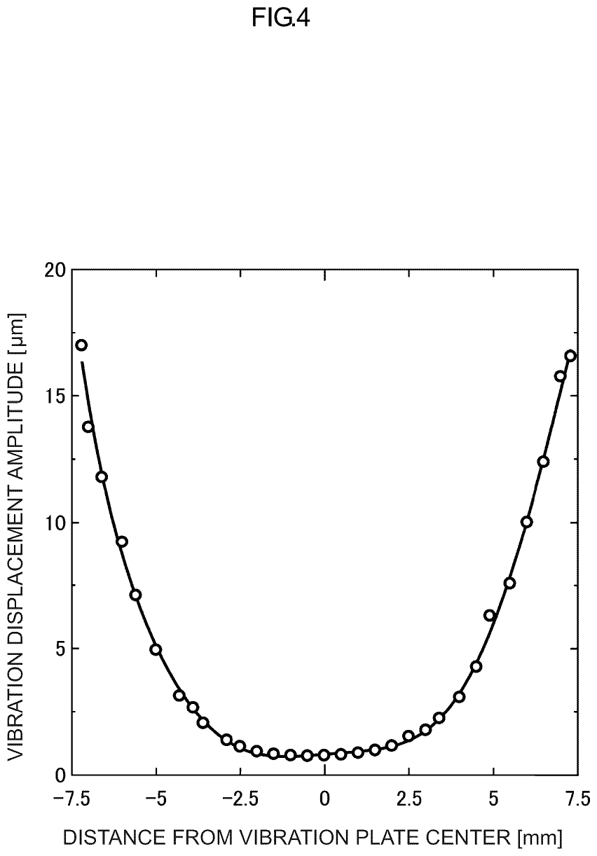

FIG. 4 shows the results of the measurement of the vibration displacement on the vibration surface. The horizontal axis in FIG. 4 shows the distance from the center of the vibration plate. The vertical axis in FIG. 4 shows the amplitude of vibration displacement. It is understood from FIG. 4 that the displacement of the vibration plate 6b increases sharply as approaching the plate edge as compared with the displacement at the center. The maximum amplitude of 17 μm was obtained at the edge of the vibration plate, and the ratio of the displacement amplitude at the plate edge to the displacement amplitude at the center was 22 times.

Subsequently, the directivity characteristic was studied. In this study, the sound pressure of sound waves projected from the ultrasonic projection device 1 was measured at different angles. In this measurement, measurement was performed by using a ⅛-inch capacitor microphone (ACO, TYPE 7118). In this measurement, the distance between the vibration surface of the vibration plate 6b and a measurement point was maintained at 300 mm (constant), and measurement was performed at intervals of 1° in 90° ranges on opposite sides of the vertical center axis (0°) of the vibration surface. The drive conditions of the ultrasonic projection device 1 are the same as in the case of study of vibration displacement amplitude.

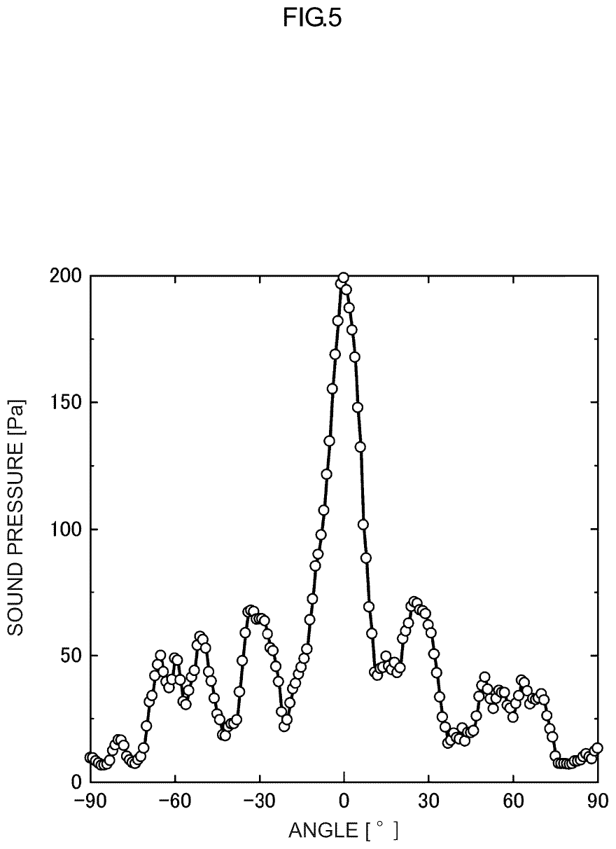

FIG. 5 shows the results of measurement of the directivity characteristic. The horizontal axis in FIG. 5 shows the angle from the center. The vertical axis in FIG. 5 shows the sound pressure. It is understood from FIG. 5 that the sound waves radiated from the vibration plate 6b have high sound pressures in the 0° direction (the direction perpendicular to the vibration surface). The maximum sound pressure of 200 Pa was obtained in the 0° direction, and the full width at half maximum was about 15°.

Subsequently, the distance characteristic was studied. In this study, the sound waves projected from the ultrasonic projection device 1 were measured at different distances from the ultrasonic projection device 1. In this measurement, measurement was performed by using the same capacitor microphone as that used in the study of the directivity characteristic. In this measurement, the microphone was disposed in the center axis perpendicular direction of the vibration surface (the 0° direction), and measurement was performed while changing the distance, by 1 mm at a time, from 1 mm to 300 mm. The drive conditions of the ultrasonic projection device 1 are the same as in the case of study of the directivity characteristic.

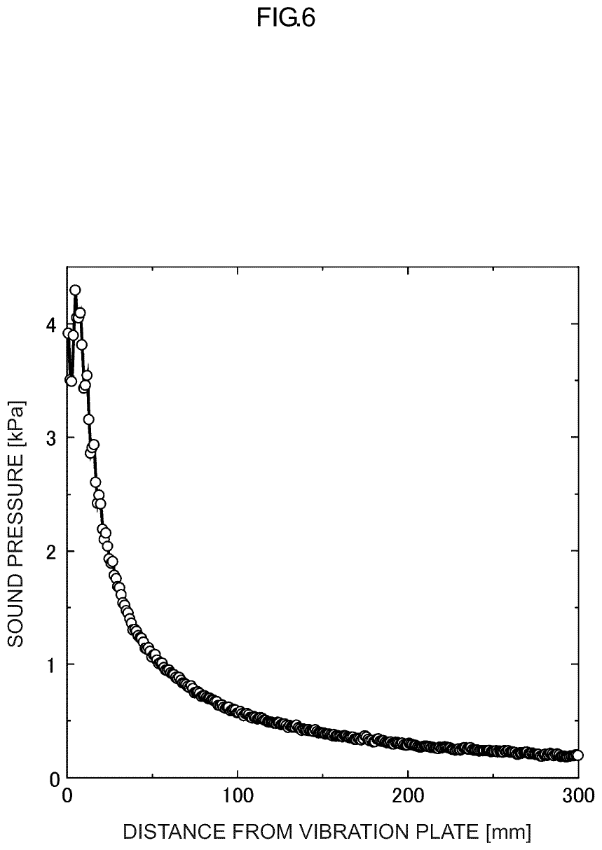

FIG. 6 shows the results of measurement of the distance characteristic. The horizontal axis in FIG. 6 shows the distance from the vibration plate 6b. The vertical axis in FIG. 6 shows the sound pressure. It is understood from FIG. 6 that the sound pressure decreases with the distance from the vibration plate 6b. The sound pressure at a distance of 300 mm was 190 Pa.

Subsequently, the relation between input electric power and sound pressure was studied. For the case where the electric power inputted to the piezoelectric units 4 was changed, the sound pressure of sound waves radiated from the ultrasonic projection device 1 was measured by using the same capacitor microphone as that used in the study of the directivity characteristic. In this measurement, the microphone was disposed in the center axis perpendicular direction of the vibration surface (the 0° direction) to be located at a distance of 300 mm from the vibration surface, and the input electric power was gradually increased from 0 W to 10 W. The drive conditions of the ultrasonic projection device 1 are the same as in the case of study of the directivity characteristic.

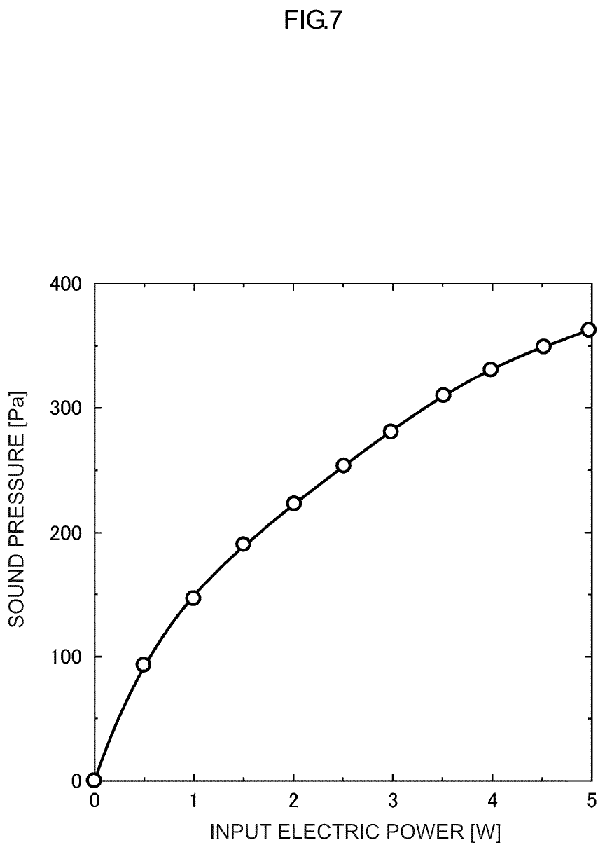

FIG. 7 shows the results of measurement of the relation between input electric power and sound pressure. The horizontal axis in FIG. 7 shows the input electric power. The vertical axis in FIG. 7 shows the sound pressure. It was found from FIG. 7 that the sound pressure increases as the input electric power increases, and the maximum sound pressure of 362 Pa (sound pressure level of 145 dB) is obtained when the input electric power is 5 W.

As described above, in the present example, for the ultrasonic projection device 1, the admittance characteristic, the vibration displacement distribution, the directivity characteristic, the distance characteristic, and the relation between input and sound pressure were studied. These study results revealed that the ultrasonic projection device 1 can radiate sound waves having strong directivity over a relatively long distance. It was found that a high pressure; i.e., the maximum sound pressure of 362 Pa, can be obtained at the distance of 300 mm in the direction perpendicular to the vibration surface.

### Second Embodiment

Next, a second embodiment of the present invention will be described. Notably, in the description of the present embodiment, as to portions identical with those of the first embodiment, their descriptions are omitted or simplified in some cases.

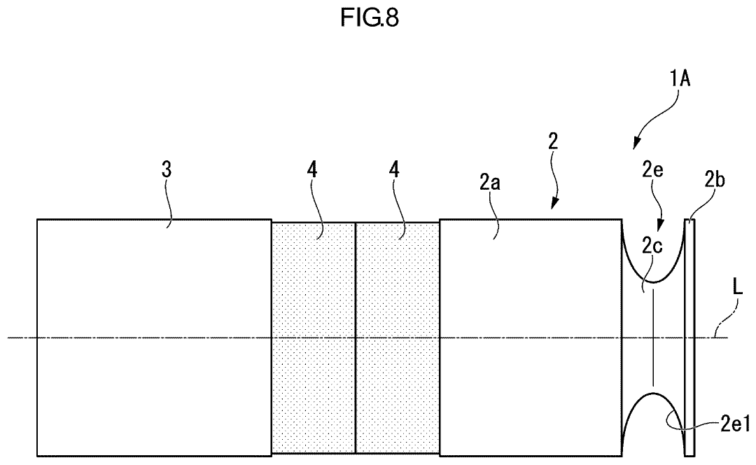

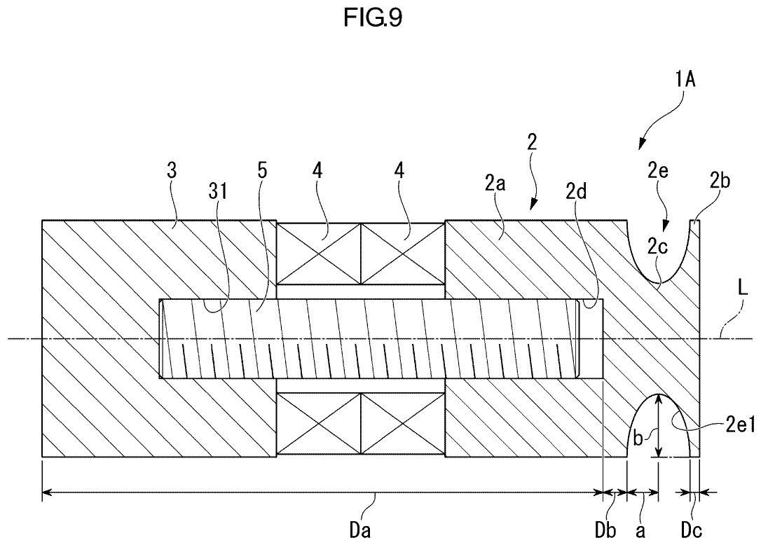

FIG. 8 is a schematic view of an ultrasonic projection device 1A of the second embodiment. FIG. 9 is a sectional view of the ultrasonic projection device 1A of the second embodiment. As shown in these drawings, the forward end member 6 in the above-described first embodiment is not provided in the ultrasonic projection device 1A of the present embodiment. Meanwhile, in the present embodiment, the first block body 2 has a base portion 2a, a vibration plate 2b, and a connection portion 2c. Namely, in the present embodiment, the vibration plate 2b is a portion of the first block body 2.

The base portion 2a is a portion formed into the shape of a circular column whose center coincides with the center axis L. The base portion 2a has a hole 2d extending in the axial direction. The hole 2d is formed in a center portion of the base portion 2a as viewed from the axial direction. The hole 2d is formed to be concave forward from the rear-side surface of the base portion 2a. An internal thread for screw engagement with the bolt 5 is formed on an inner wall surface of the hole 2d. For example, the diameter of the hole 2d is the same as the diameter of the hole 31 of the second block body 3. However, the diameter of the hole 2d may differ from the diameter of the hole 31. The base portion 2a directly or indirectly supports the vibration plate 2b and the connection portion 2c. The connection portion 2c is connected to the forward side of the base portion 2a.

The vibration plate 2b is located forward of the base portion 2a and is connected to the base portion 2a via the connection portion 2c. The vibration plate 2b is a disk-shaped portion formed into a circular shape as viewed from the axial direction. The vibration plate 2b vibrates when vibrations generated by the piezoelectric units 4 are transmitted thereto. As a result of vibration of the vibration plate 2b, ultrasonic waves are radiated. In the present embodiment, the diameter of the vibration plate 2b is the same as the diameter of the base portion 2a. However, the diameter of the vibration plate 2b may differ from the diameter of the base portion 2a. Namely, the diameter of the vibration plate 2b may be larger or smaller than the diameter of the base portion 2a.

The connection portion 2c is provided between the base portion 2a and the vibration plate 2b and supports the vibration plate 2b. This connection portion 2c has a groove 2e annularly provided around the center axis L. The groove 2e has a smooth inner wall surface 2e1 which connects the vibration plate 2b and the base portion 2a. The term “smooth” used herein means that the entirety is formed by a curved surface or a flat surface and a rough portion is not provided.

As described above, the groove 2e is annularly formed around the center axis L along the axial direction. As shown in FIG. 9, a sectional shape of the groove 2e on a plane containing the center axis L is a semi-elliptical shape which is concave inward from the outer side in the radial direction. The minor axis of the semi-elliptical shape is parallel to the center axis L. The major axis of the semi-elliptical shape is parallel to the radial direction.

However, the sectional shape of the groove 2e may be a semi-elliptical shape in which the minor axis is parallel to the radial direction, and the major axis is parallel to the center axis L. The sectional shape of the groove 2e may be a semi-circular shape or a horseshoe shape. The groove 2e may have any sectional shape so long as its entirety is a curved surface or its entirety is a surface which is formed by combining a curved surface(s) and a flat surface(s) and which does not have a rough portion.

In the ultrasonic projection device 1A of the present embodiment configured as described above, when electric power is supplied from an external drive section to the piezoelectric units 4, the piezoelectric units 4 vibrate. As a result of setting the drive frequency of the piezoelectric units 4 to the resonance frequency of the ultrasonic projection device 1A, the ultrasonic projection device 1A resonates with the vibration of the piezoelectric units 4. As a result, the vibration plate 2b strongly vibrates and ultrasonic waves with high sound pressure are generated. The generated ultrasonic waves are radiated into a space. The ultrasonic projection device 1A of the present embodiment configured as described above projects the ultrasonic waves generated by the vibration plate 2b into the space.

In the present embodiment, an overall length of the ultrasonic projection device 1A is set to half of the wavelength of longitudinal vibration at the time when the ultrasonic projection device 1A resonates as described above. Namely, the overall length of the ultrasonic projection device 1A is set to half of the wavelength of the vibration generated by the piezoelectric units 4. One end of the ultrasonic projection device 1A in the axial direction is the rear-side end surface of the second block body 3. The other end of the ultrasonic projection device 1A in the axial direction is the forward-side surface of the vibration plate 2b. Therefore, the distance dimension from the rear-side end surface of the second block body 3 to the forward-side surface of the vibration plate 2b is set to half of the wavelength of the vibration generated by the piezoelectric units 4. In the ultrasonic projection device 1A of the present embodiment configured as described above, the vibration plate 2b is disposed at a position of a peak of longitudinal vibration at the time when the ultrasonic projection device 1A resonates. As a result, the amplitude of vibration of the vibration plate 2b can be increased, and ultrasonic waves with higher sound pressure can be outputted.

The ultrasonic projection device 1A of the present embodiment as described above includes the first block body 2, the second block body 3, and the piezoelectric units 4. The piezoelectric units 4 are sandwiched between the first block body 2 and the second block body 3. The first block body 2 has the vibration plate 2b, the base portion 2a, and the connection portion 2c. The vibration plate 2b is provided at one end of the first block body 2 on the side opposite the piezoelectric units 4 in the axial direction. The base portion 2a is abutted against the piezoelectric units 4. The connection portion 2c is provided between the vibration plate 2b and the base portion 2a, which supports the vibration plate 2b. The connection portion 2c has the groove 2e having the smooth inner wall surface 2e1 which connects the vibration plate 2b and the base portion 2a.

In the ultrasonic projection device 1A of the present embodiment configured as described above, the groove 2e is provided in the connection portion 2c which connects the vibration plate 2b and the base portion 2a. Therefore, an edge portion of the vibration plate 2b can move greatly without being restrained by the connection portion 2c, and the sound pressure of ultrasonic waves projected from the vibration plate 2b can be increased. Furthermore, since the inner wall surface 2e1 of the groove 2e is smooth, it is possible to prevent occurrence of local stress concentration on the inner wall surface 2e1. Therefore, it is possible to increase the amplitude of vibration of the vibration plate 2b, thereby increasing the sound pressure of ultrasonic waves projected from the vibration plate 2b. Accordingly, the ultrasonic projection device 1A of the present embodiment can further increase the sound pressure of ultrasonic waves.

In the ultrasonic projection device 1A of the present embodiment, the distance dimension from one end on the first block body 2 side in the axial direction to the other end on the second block body 3 side is equal to half of the wavelength of the vibration generated by the piezoelectric units 4. Namely, according to the ultrasonic projection device 1A of the present embodiment, the distance dimension from the rear-side end surface of the second block body 3 to the forward-side surface of the vibration plate 2b is set to half of the wavelength of the vibration generated by the piezoelectric units 4. In the ultrasonic projection device 1A of the present embodiment configured as described above, the vibration plate 2b is disposed at the position of the peak of longitudinal vibration at the time when the ultrasonic projection device 1A resonates. As a result, the amplitude of vibration of the vibration plate 2b can be increased, and ultrasonic waves with higher sound pressure can be outputted.

In the ultrasonic projection device 1A of the present embodiment, the vibration plate 2b is a portion of the first block body 2. Therefore, it is unnecessary to provide the forward end member 6 used in the above-described first embodiment, separately from the first block body 2. Therefore, it is possible to render the overall length of the ultrasonic projection device 1A shorter than the overall length of the ultrasonic projection device 1 of the above-described first embodiment. Also, it is possible to render the number of components of the ultrasonic projection device 1A smaller than that in the above-described first embodiment, thereby simplifying the structure.

However, in the ultrasonic projection device 1A of the present embodiment, the distance dimension from the one end on the first block body 2 side in the axial direction to the other end on the second block body 3 side in the axial direction is not necessarily required to be equal to half of the wavelength of the vibration generated by the piezoelectric units 4. For example, the distance dimension from the one end on the first block body 2 side in the axial direction to the other end on the second block body 3 side in the axial direction may be equal to the wavelength of the above-described vibration or 1.5 times the wavelength. Even in the case where, as described above, the distance dimension from the one end on the first block body 2 side in the axial direction to the other end on the second block body 3 side in the axial direction is not equal to half of the wavelength of the above-described vibration, since the vibration plate 2b is a portion of the first block body 2, it is possible to render the number of components of the ultrasonic projection device 1A smaller than that in the above-described first embodiment.

In the ultrasonic projection device 1A of the present embodiment, the groove 2e is annularly formed around the center axis L along the axial direction. The sectional shape of the groove 2e on a plane containing the center axis L is a semi-elliptical shape which is concave inward from the outer side in the radial direction. As a result of provision of the groove 2e whose sectional shape is a semi-elliptical shape, ultrasonic waves which are high in directivity and sound pressure can be outputted.

In the ultrasonic projection device 1A of the present embodiment, the semi-elliptical shape, which is the sectional shape of the groove 2e, is such that the minor axis is parallel to the center axis L, and the major axis is parallel to the radial direction. Therefore, it is possible to shorten the overall length of the ultrasonic projection device 1A, as compared with the case where the major axis is parallel to the center axis L, thereby reducing the size of the ultrasonic projection device 1A.

### Example

Subsequently, the results of simulation performed by using the ultrasonic projection device 1A of the above-described second embodiment will be described as an example. In the present example, the length dimension Da shown in FIG. 9 (the distance dimension from the rear end of the second block body 3 to the forward end of the hole 2d) was set to 35.5 mm. More specifically, the distance dimension from the rear end to the forward end of the second block body 3 was set to 14.8 mm, the distance dimension from the rear end to the forward end of the piezoelectric units 4 was set to 10.7 mm, and the distance dimension from the rear end of the first block body 2 to the forward end of the hole 2d was set to 10 mm.

The distance dimension Db from the forward end of the hole 2d to the forward end of the base portion 2a was changed at 0.5 mm intervals from 1 mm to 5 mm. Notably, the overall length of the ultrasonic projection device 1A (the distance dimension from the rear end of the second block body 3 to the forward-side surface of the vibration plate 2b) was 41.0 mm when the distance dimension Db was 1 mm. The thickness dimension Dc of the vibration plate 2b was set to 0.5 mm. The minor radius a of the semi-elliptical shape, which is the sectional shape of the groove 2e, was changed at 0.1 mm intervals from 2 mm to 2.5 mm. Also, the major radius b of the semi-elliptical shape, which is the sectional shape of the groove 2e, was changed at 0.1 mm intervals from 4 mm to 4.5 mm. A specified displacement of 1.5 m was applied to the rear end of the second block body 3.

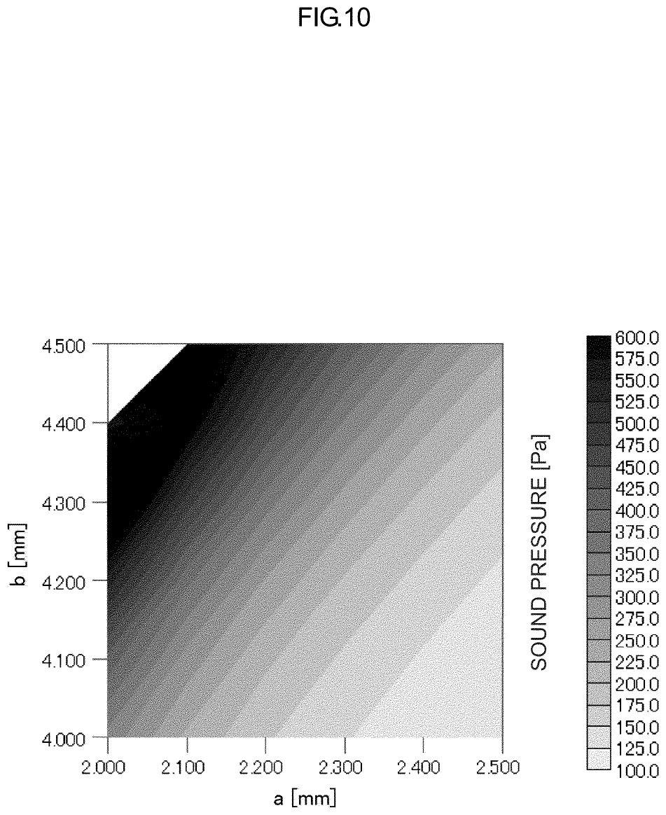

In the present example, under the above-described conditions, the sound pressure at a position 300 mm forward of the center of the vibration plate 2b was evaluated. FIG. 10 shows the results of simulation which represents the distribution of sound pressure obtained by changing the minor radius a and the major radius b. Notably, in the graph shown in FIG. 10 and representing the results, of a plurality of sound pressures obtained by changing the distance dimension Db while maintaining the same minor radius a and the same major radius b, the highest sound pressure is used.

It is understood from FIG. 10 that a high sound pressure of 100 Pa or higher can be obtained irrespective of changes in the minor radius a and the major radius b. Also, it is understood from FIG. 10 that the sound pressure tends to increase when the minor radius a is made shorter. Also, it is understood from FIG. 10 that the sound pressure tends to increase when the major radius b is made longer.

Notably, in the present example, the frequency changed in the range of 54.4 kHz to 60.7 kHz. The amount of change in the frequency caused by change in the minor radius a was not large, and the larger the major radius b, the greater the degree to which the frequency decreased.

### Third Embodiment

Next, a third embodiment of the present invention will be described. Notably, in the description of the present embodiment, as to portions identical with those of the above-described second embodiment, their descriptions are omitted or simplified in some cases.

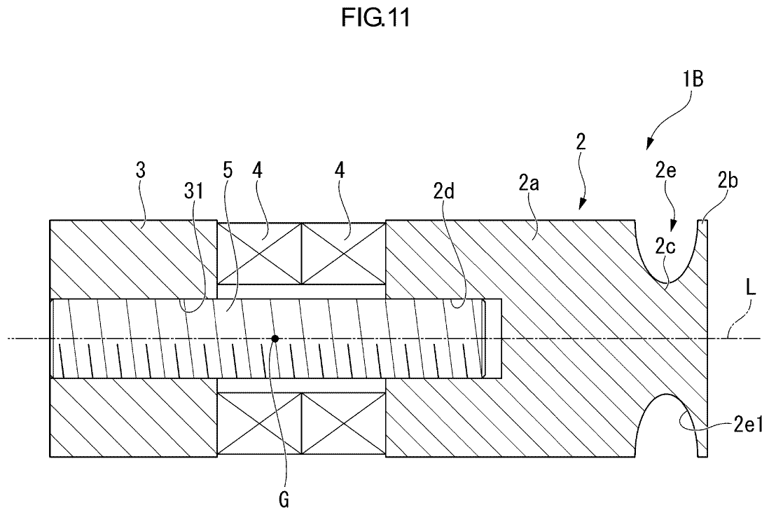

FIG. 11 is a sectional view schematically showing the structure of an ultrasonic projection device 1B of the third embodiment. As shown in this drawing, in the ultrasonic projection device 1B of the present embodiment, the hole 31 of the second block body 3 penetrates the second block body 3 in the axial direction. In the present embodiment, the bolt 5 is disposed at a position shifted rearward from the position in the first embodiment. In the present embodiment, as shown in FIG. 11, the center of gravity G of the bolt 5 is located closer to the second block body 3 than to the first block body 2.

In the ultrasonic projection device 1B of the present embodiment configured as described above, since the bolt 5 is disposed on the rear side, it is possible to secure a long distance from the forward end of the hole 2d provided in the base portion 2a to the forward end of the base portion 2a. Therefore, the thickness of the base portion 2a as measured forward from the forward end of the hole 2d can be made larger that that in the above-descried first embodiment. Accordingly, the ultrasonic projection device 1B of the present embodiment has enhanced durability.

In the present embodiment, the first block body 2 may be formed of a material whose specific gravity is smaller than that of the second block body 3. In such a case, for example, the first block body 2 may be formed of aluminum, and the second block body 3 may be formed of stainless steel. Since the first block body 2 is formed of a material whose specific gravity is smaller than that of the second block body 3, the weight of the first block body 2 is reduced, and thus, it becomes possible to increase the amplitude of vibration of the vibration plate 2b. As a result, sound pressure can be further increased.

Notably, in the above-described first embodiment, the first block body 2 and the forward end member 6 may be formed of a material whose specific gravity is smaller than that of the second block body 3. Also, in the above-described second embodiment, the first block body 2 may be formed of a material whose specific gravity is smaller than that of the second block body 3. In either case, the amplitude of vibration of the vibration plate 6b or the vibration plate 2b, and, thus, sound pressure can be further increased.

### Fourth Embodiment

Next, a fourth embodiment of the present invention will be described. Notably, in the description of the present embodiment, as to portions identical with those of the above-described second embodiment, their descriptions are omitted or simplified in some cases.

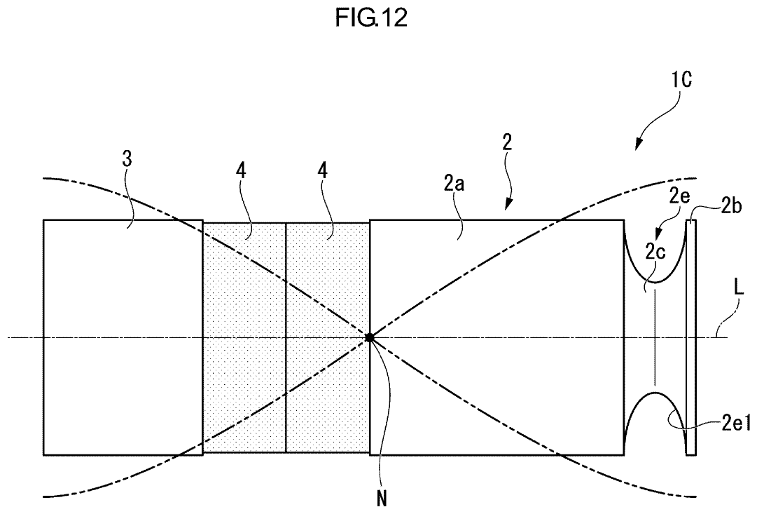

FIG. 12 is a schematic view of an ultrasonic projection device 1C of the fourth embodiment. Two-dot chain lines shown in FIG. 12 schematically show longitudinal vibration waves in the case where the ultrasonic projection device 1C resonates. As shown in FIG. 12, in the ultrasonic projection device 1C of the present embodiment, the boundary between the first block body 2 and the piezoelectric units 4 is located at the position of a node N. Namely, in the ultrasonic projection device 1C of the present embodiment, the boundary between the first block body 2 and the piezoelectric units 4 is located at the position in the axial direction which coincides with a node of the vibration generated by the piezoelectric units 4.

In the case where the boundary between the first block body 2 and the piezoelectric units 4 is located at the position of the node N as described above, it is possible to suppress heat generation as compared with the case where the position of the node N is located in the piezoelectric units 4. Also, the end surface of the first block body 2 on the piezoelectric units 4 side does not move due to vibration. Therefore, it becomes possible to easily fix the ultrasonic projection device 1C to an external member via the end surface of the first block body 2 on the piezoelectric units 4 side.

Preferred embodiments of the present invention have been described above with reference to the attached drawings. However, needless to say, the present invention is not limited to the above-described embodiments. The shapes, combinations, etc. of the constituent members shown in the above-described embodiments are mere examples, and they can be changed in various manners on the basis of design requirements, etc., without departing from the purpose of the present invention.

### DESCRIPTION OF REFERENCE SIGNS

1: ultrasonic projection device, 1A: ultrasonic projection device, 1B: ultrasonic projection device, 1C: ultrasonic projection device, 2: first block body, 2a: base portion, 2b: vibration plate, 2c: connection portion, 2d: hole, 2e: groove, 2e1: inner wall surface, 3: second block body, 4: piezoelectric unit (vibration generation section), 5: bolt, 6: forward end member, 6a: base portion, 6b: vibration plate, 6c: connection portion, 6d: shaft portion, 6e: groove, 6e1: inner wall surface, 21: through hole, 31: hole, a: minor radius, b: major radius, G: center of gravity, L: center axis, N: node

What is claimed is:

1. An ultrasonic projection device for projecting ultrasonic waves, comprising:
a first block body;
a second block body; and
a vibration generation section sandwiched between the first block body and the second block body,
wherein a vibration plate is provided at one end on a side where the first block body is present as viewed in a direction of arrangement of the first block body, the second block body, and the vibration generation section,
wherein a dimension in the direction of arrangement from the one end to the other end on a side where the second block body is present approximately coincides with half of the wavelength of vibration generated by the vibration generation section, and
wherein a connection portion is provided between the vibration plate and a base portion which supports the vibration plate, the connection portion having a groove with a smooth inner wall surface which connects the vibration plate and the base portion.

2. The ultrasonic projection device according to claim 1, wherein a forward end member having the vibration plate, the connection portion, and the base portion is provided separately from the first block body, and
the forward end member is fixed to the first block body.

3. The ultrasonic projection device according to claim 1, wherein the first block body has the vibration plate, the connection portion, and the base portion.

4. An ultrasonic projection device for projecting ultrasonic waves, comprising:
a first block body;
a second block body; and
a vibration generation section sandwiched between the first block body and the first block body,
wherein the first block body includes:
a vibration plate provided on a side opposite the vibration generation section in a direction of arrangement of the first block body, the second block body, and the vibration generation section,
a base portion abutted against the vibration generation section, and
a connection portion provided between the vibration plate and the base portion and having a groove with a smooth inner wall surface which connects the vibration plate and the base portion.

5. The ultrasonic projection device according to claim 1, wherein the groove is annularly formed around a center axis extending in the direction of arrangement, and a sectional shape of the groove on a plane containing the center axis is a semi-elliptical shape which is concave inward from an outer side in a radial direction with respect to the center axis.

6. The ultrasonic projection device according to claim 5, wherein the semi-elliptical shape has a minor axis parallel to the center axis and a major axis parallel to the radial direction.

7. The ultrasonic projection device according to claim 1, further comprising a bolt which is threadedly engaged, at one end, with the first block body and threadedly engaged, at the other end, with the second block body,
wherein the bolt has a center of gravity at a position which is closer to the second block body than to the first block body in the direction of arrangement.

8. The ultrasonic projection device according to claim 1, wherein the first block body is formed of a material whose specific gravity is smaller than that of the second block body.

9. The ultrasonic projection device according to claim 1, wherein a boundary between the first block body and the vibration generation section is located at a position in the direction of arrangement which corresponds to a node of vibration generated by the vibration generation section.

10. The ultrasonic projection device according to claim 4, wherein the groove is annularly formed around a center axis extending in the direction of arrangement, and a sectional shape of the groove on a plane containing the center axis is a semi-elliptical shape which is concave inward from an outer side in a radial direction with respect to the center axis.

11. The ultrasonic projection device according to claim 10, wherein the semi-elliptical shape has a minor axis parallel to the center axis and a major axis parallel to the radial direction.

12. The ultrasonic projection device according to claim 4, further comprising a bolt which is threadedly engaged, at one end, with the first block body and threadedly engaged, at the other end, with the second block body,
wherein the bolt has a center of gravity at a position which is closer to the second block body than to the first block body in the direction of arrangement.

13. The ultrasonic projection device according to claim 4, wherein the first block body is formed of a material whose specific gravity is smaller than that of the second block body.

14. The ultrasonic projection device according to claim 4, wherein a boundary between the first block body and the vibration generation section is located at a position in the direction of arrangement which corresponds to a node of vibration generated by the vibration generation section.
